(19) United States
(12) Patent Application Publication
(10) Pub. No.: US 2024/0278738 A1
(43) Pub. Date: Aug. 22, 2024

(54) WIRE HARNESS CLAMP ATTACHMENT STRUCTURE

(71) Applicant: TOYOTA JIDOSHA KABUSHIKI KAISHA, Toyota-shi (JP)

(72) Inventor: Mitsuhisa YOSHINAGA, Nisshin-shi (JP)

(73) Assignee: TOYOTA JIDOSHA KABUSHIKI KAISHA, Toyota-shi (JP)

(21) Appl. No.: 18/390,716

(22) Filed: Dec. 20, 2023

(30) Foreign Application Priority Data
Feb. 22, 2023 (JP) 2023-026750

(51) Int. Cl. B60R 16/02; F16B 21/02

(52) U.S. Cl. CPC B60R 16/0215; F16B 21/02; H02G 3/32

(57) ABSTRACT

The insertion portion of the clamp is inserted into an attachment hole formed through the floor panel. The pair of elastic pieces of the insertion portion is elastically deformable in opposite directions to each other in a direction orthogonal to the insertion direction of the insertion portion, and can be locked to the pair of locked edges of the attachment hole. I can do it. The attachment hole has a shape that allows the clamp to be rotated within a predetermined range around the axis in the insertion direction of the insertion part from the locked state in which the pair of elastic pieces is locked to the pair of locked edges. Further, when the clamp is rotated by a predetermined angle from the locked state, the hole edge is located outside the outer shape of the insertion portion in plan view.

### CROSS-REFERENCE TO RELATED APPLICATION

This application claims priority to Japanese Patent Application No. 2023-026750 filed on Feb. 22, 2023, incorporated herein by reference in its entirety.

### BACKGROUND

### 1. Technical Field

The present disclosure relates to a wire harness clamp attachment structure.

### 2. Description of Related Art

Japanese Unexamined Patent Application Publication No. 11-123992 (JP 11-123992 A) discloses a technology related to a structure for attaching an automobile wire harness to a body. To give a brief description in this related art, a clamp fixing plate having vertical walls on both sides and a top wall is fixed to an attachment surface of an automobile body, and a long locking hole is formed at the center of the top wall of the plate to divide the top wall into two parts. In this related art, the clamp can be locked and fixed to the plate by pushing a locking portion of the clamp attached to the wire harness into the long locking hole. The clamp can be removed without damage by sliding the clamp along the long locking hole and pulling it from a tip opening.

### SUMMARY

In this related art, however, the clamp is detached only by sliding along the long locking hole. Therefore, there is room for improvement in suppressing detachment of the attached clamp.

In view of the above fact, the present disclosure has an object to obtain a wire harness clamp attachment structure in which detachment of an attached clamp can be suppressed and the clamp can be removed without damage.

A wire harness clamp attachment structure according to a first aspect of the present disclosure is
a structure for attaching, to a vehicle body-side component, a clamp including a base plate portion to which a wire harness is fixed on one side.

An insertion portion to be inserted into an attachment hole in the vehicle body-side component is provided on the other side of the base plate portion of the clamp, and the insertion portion includes a pair of elastic pieces that is elastically deformable in a mutually facing direction orthogonal to an insertion direction of the insertion portion.

The attachment hole includes a pair of locked edges configured to lock the elastic pieces, and has a shape in which the clamp is rotatable within a predetermined range about an axis in the insertion direction of the insertion portion from a locked state in which the elastic pieces are locked on the locked edges, and a hole edge is located on an outer side of an external shape of the insertion portion in plan view when the clamp is rotated by a predetermined angle from the locked state.

The “vehicle body-side component” includes not only a member that constitutes a vehicle body, but also a member fixed to the member that constitutes the vehicle body.

According to the above configuration, the wire harness is fixed to the one side of the base plate portion of the clamp, and the insertion portion is provided on the other side of the base plate portion of the clamp. The insertion portion is inserted into the attachment hole in the vehicle body-side component. The elastic pieces of the insertion portion are elastically deformable in the mutually facing direction orthogonal to the insertion direction of the insertion portion, and can be locked on the locked edges of the attachment hole.

The attachment hole has the shape in which the clamp is rotatable within the predetermined range about the axis in the insertion direction of the insertion portion from the locked state in which the elastic pieces are locked on the locked edges. Further, the attachment hole has the shape in which the hole edge is located on the outer side of the external shape of the insertion portion in plan view when the clamp is rotated by the predetermined angle from the locked state. Therefore, the clamp can be removed without damage by rotating the clamp from the locked state by the predetermined angle about the axis in the insertion direction of the insertion portion and pulling out the insertion portion from the attachment hole. The clamp is not detached from the vehicle body-side component unless the clamp is rotated by the predetermined angle about the axis in the insertion direction of the insertion portion from the locked state and then the insertion portion is pulled out from the attachment hole. Therefore, the detachment of the clamp from the vehicle body-side component is suppressed.

In the wire harness clamp attachment structure according to the first aspect of the present disclosure,
the vehicle body-side component may include a protrusion that is located near the base plate portion of the clamp in the locked state and is configured to restrict rotation of the clamp by the predetermined angle from the locked state by contact with the base plate portion.

The clamp may be configured to allow the base plate portion to climb over the protrusion by rotating about the axis in the insertion direction of the insertion portion while elastically bending the base plate portion on the vehicle body-side component away from the vehicle body-side component.

According to the above configuration, the protrusion on the vehicle body-side component is located near the base plate portion of the clamp in the locked state and is configured to restrict the rotation of the clamp by the predetermined angle from the locked state by contact with the base plate portion. The clamp is configured to allow the base plate portion to climb over the protrusion by rotating about the axis in the insertion direction of the insertion portion while elastically bending the base plate portion on the vehicle body-side component away from the vehicle body-side component. Therefore, the rotation of the clamp attached to the vehicle body-side component can be restricted satisfactorily and the clamp can be removed without damage.

As described above, the present disclosure has an excellent effect that the detachment of the attached clamp can be suppressed and the clamp can be removed without damage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a wire harness clamp attachment structure according to an embodiment;

FIG. 2 is a sectional view taken along line 2-2 in FIG. 1;

FIG. 3 is a simplified plan view showing the positional relationship between the attachment hole of the floor panel and the insertion portion of the clamp in the locked state; and

FIG. 4 is a simplified plan view showing a state in which the clamp is rotated by a predetermined angle from the state in FIG. 3.

### DETAILED DESCRIPTION OF EMBODIMENTS

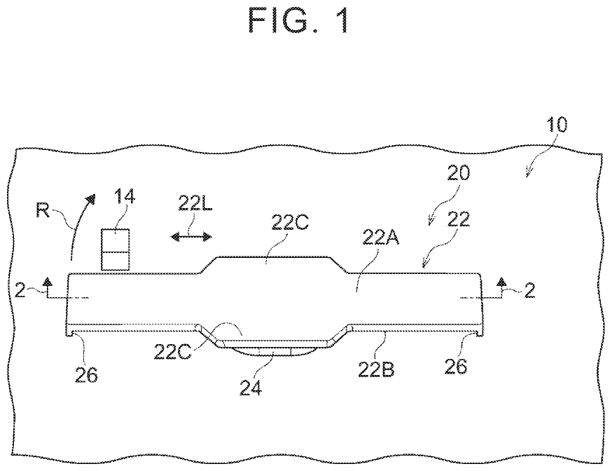

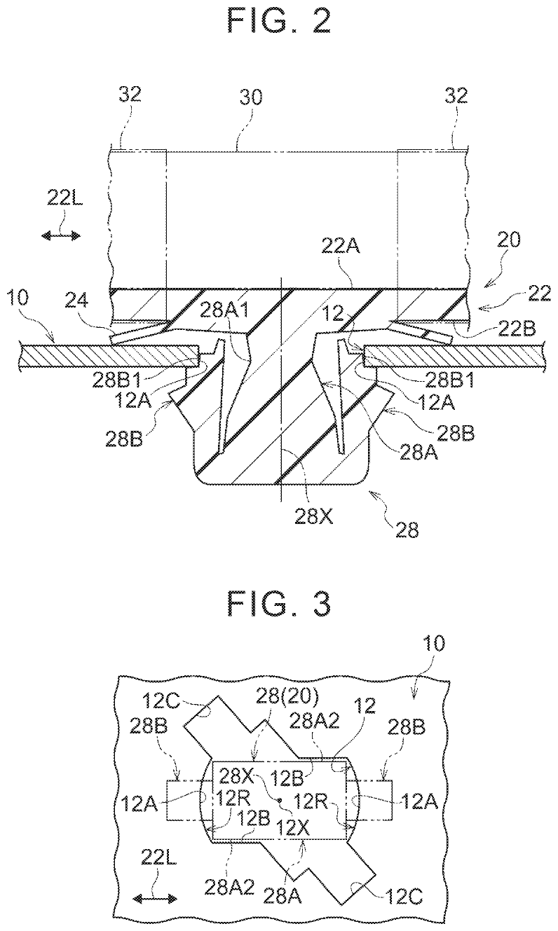

A wire harness clamp attachment structure according to an embodiment will be described with reference to FIGS. 1 to 4. FIG. 1 shows a perspective view of a wire harness clamp attachment structure according to an embodiment. FIG. 2 shows a cross-sectional view taken along line 2-2 in FIG. 1. The wire harness clamp attachment structure according to the embodiment is a structure in which a wire harness clamp 20 is attached to a floor panel (vehicle body floor panel) 10 as a vehicle body-side component. Note that the floor panel 10 is a panel member that constitutes a vehicle floor, and is an example of a vehicle body-side component.

The clamp 20 shown in FIGS. 1 and 2 is made of synthetic resin. Further, the clamp 20 includes a board portion 22 to which a wire harness 30 (see FIG. 2) is fixed on a first surface 22A, and an insertion portion 28 provided on a second surface 22B as the other surface of the board portion 22 (see FIG. 2). As the basic structure of the clamp 20, a known structure such as the basic structure of a wire harness clamp disclosed in Japanese Unexamined Patent Application Publication No. 2010-252555 can be applied. An example of the clamp 20 will be briefly described below.

As shown in FIG. 1, the board portion 22 of the clamp 20 is a flat plate-shaped portion that is elongated in a predetermined direction when viewed from above. A longitudinally intermediate portion of the board portion 22 is provided with an overhang portion 22C that slightly protrudes in the width direction (a direction perpendicular to the longitudinal direction of the board portion 22). In addition, in the following description, for convenience, the longitudinal direction of the board portion 22 is suitably called the board longitudinal direction 22L.

A lip portion 24 extends from a longitudinally intermediate portion of the board portion 22 on the second surface 22B side. The lip portion 24 is formed in the shape of a fin, and the outer shape of the board portion 22 when viewed from the bottom is formed into a long track shape (a shape formed by connecting semicircles with straight lines) in the same direction as the longitudinal direction of the board portion 22. As shown in FIGS. 1 and 2, the lip portion 24 is pressed against the floor panel 10 and elastically deforms. Furthermore, as shown in FIG. 1, convex portions 26 are formed to protrude from both longitudinal ends of the board portion 22 on the second surface 22B side. The convex portion 26 is arranged such that its protruding tip side is in contact with the floor panel 10.

As shown in FIG. 2, the board portion 22 can be wound around a vinyl tape 32 (only the outer shape is shown by the two-dot chain line in the figure) with the wire harness 30 (only the outer shape is shown by the two-dot chain line in the figure) placed on the first surface 22A. That is, the wire harness 30 is held on the board portion 22 with vinyl tape 32 or the like. The vinyl tape 32 is arranged between the lip portion 24 and the convex 15 portion 26 (see FIG. 1) on the second surface 22B side of the board portion 22.

The insertion portion 28 of the clamp 20 is a portion that is inserted into the attachment hole 12 formed through the floor panel 10. The insertion portion 28 is formed with a protrusion 28A that protrudes from the second surface 22B of the board portion 22, and is formed with a pair of extended elastic pieces 28B that is continuous with the protrusion tip side of the protrusion 28A and extends toward the second surface 22B side of the board portion 22. Note that the pair of elastic pieces 28B is elements that can be understood as a lock portion.

A constricted portion 28A1 that is slightly constricted in the direction along the board longitudinal direction 22L is formed at the base side portion of the protrusion 28A. Further, a portion of the protrusion 28A closer to the protruding tip than the constricted portion 28A1 is formed in a shape that gradually widens in the direction along the board longitudinal direction 22L toward the protruding tip.

The pair of elastic pieces 28B is elastically deformable in directions perpendicular to the insertion direction of the insertion portion 28 and opposite to each other. The opposing direction of the pair of elastic pieces 28B is set to be the same as the board longitudinal direction 22L. The intermediate portions of the pair of elastic pieces 28B in the extending direction are convex on the side opposite to the protrusion 28A side. In addition, the front end side of the pair of elastic pieces 28B has a stepped surface on the side opposite to the protrusion 28A side, and a part thereof serves as a locking portion 28B1 for locking into the attachment hole 12.

On the other hand, the attachment hole 12 of the floor panel 10 has a pair of locked edges 12A that can lock the locking portion 28B1 of the pair of elastic pieces 28B. FIG. 3 shows a plan view of a portion of the floor panel 10 including the attachment holes 12. Further, in FIG. 3, the outer shape of the insertion portion 28 of the clamp 20 in the locked state (attached state) is simplified and shown by a two-dot chain line. As shown in FIG. 3, the attachment hole 12 is formed in a shape different from a general long hole (deformed shape). The relationship between the attachment hole 12 and the insertion portion 28 of the clamp 20 will be described below.

When the clamp 20 is in the locked state, a portion of each of the pair of clastic pieces 28B does not overlap the attachment hole 12 in plan view. In other words, when the clamp 20 is in the locked state, the distance between the pair of locked edges 12A in the attachment hole 12 is shorter than the length of the insertion portion 28 of the clamp 20 in the board longitudinal direction 22L. The attachment hole 12 is formed with an arcuate edge 12R that is composed of a locked edge 12A and extensions on both sides thereof. The arcuate edge 12R is, for example, formed in an arc shape centered on the center point 12X of the attachment hole 12 in plan view.

Further, the attachment hole 12 is formed with an abutted edge 12B that is abutted by a portion 28A2 of the end of the protrusion 28A in the short direction when viewed from above when the clamp 20 is in the locked state. In addition, in the drawing, in order to make the drawing easier to read, a portion 28A2 of the end portion of the protrusion 28A in the short direction in plan view and the abutted edge 12B of the attachment hole 12 are shown slightly separated from each other. The abutted edges 12B are linear in plan view and are provided at two locations in total, and one end is continuous with the arcuate edge 12R. Further, the two abutted edges 12B are provided at positions that are symmetrical with respect to the center point 12X of the attachment hole 12 in plan view.

A notch 12C is formed in the attachment hole 12 so as to expand the hole in a diagonal direction with respect to the direction in which the pair of arcuate edges 12R faces each other in plan view. The edge of the notch 12C is formed to connect the arcuate edge 12R and the abutted edge 12B. When the clamp 20 is in the locked state, the portion of the end portion of the protrusion 28A in the lateral direction that does not contact the abutted edge 12B is arranged so as to face the notch 12C when viewed from above. The attachment hole 12 in which the notch 12C is formed allows the clamp 20 to be moved around the axis 28X in the insertion direction of the insertion portion 28 from the locked state in which the pair of clastic pieces 28B are locked to the pair of locked edges 12A. It is formed in a shape that can be rotated within a predetermined range.

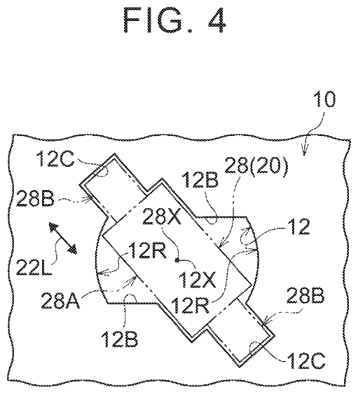

In plan view, the length of the attachment hole 12 in the diagonal direction in which the notch 12C extends from the arcuate edge 12R is longer than the length of the insertion portion 28 in the board longitudinal direction 22L when the clamp 20 is in its natural state (state in which it is not deformed). The attachment hole 12 allows the clamp 20 to be inserted in the insertion direction of the insertion portion 28 from the locked state in which the pair of elastic pieces 28B shown in FIGS. 2 and 3 are locked to the pair of locked edges 12A. When rotated by a predetermined angle around the axis 28X, the hole edge is located outside the outer shape of the insertion portion 28 in plan view, as shown in FIG. 4. In addition, in FIG. 4, the outer shape of the insertion portion 28 is simplified and illustrated by a two-dot chain line. Further, the notch 12C in this embodiment is formed within a range that does not excessively expand the penetration range, taking into account the outer shape of the insertion portion 28 of the clamp 20 in the state shown in FIG. 4 in plan view. Note that the attachment hole 12 is formed at a position where the entire attachment hole 12 is covered by a lip portion 24 shown in FIG. 1 as an example, when the clamp 20 is in the locked state.

Further, as shown in FIG. 1, the floor panel 10 is formed with a protrusion 14 located near the board portion 22 of the clamp 20 in the locked state. The protrusion 14 has a flock shape, for example, and restricts rotation of the clamp 20 from the locked state to the predetermined angle by coming into contact with the board portion 22. Further, the clamp 20 rotates around the axis 28X in the insertion direction of the insertion portion 28 (see FIG. 2 for both) while elastically bending the board portion 22 on the floor panel 10 away from the floor panel 10. By doing so (see arrow R), the board portion 22 is configured to be able to climb over the protrusion 14.

Next, the operation and effects of this embodiment will be described.

In this embodiment, as shown in FIG. 2, the insertion portion 28 provided on the second surface 22B side of the board portion 22 of the clamp 20 is inserted into the attachment hole 12 formed through the floor panel 10. The pair of elastic pieces 28B of the insertion portion 28 can be elastically deformed in opposite directions to each other in a direction perpendicular to the insertion direction of the insertion portion 28, and can be locked to a pair of locked edges 12A of the attachment hole 12. When the pair of elastic pieces 28B is locked to the pair of locked edges 12A, the pair of elastic pieces 28B is pressed against the pair of locked edges 12A by their own elastic force.

Here, the attachment hole 12 allows the clamp 20 to be moved within a predetermined range around the axis 28X in the insertion direction of the insertion portion 28 from the locked state in which the pair of elastic pieces 28B are locked to the pair of locked edges 12A. It has a shape that can be rotated. The attachment hole 12 is further formed in a shape such that when the clamp 20 is rotated by a predetermined angle from the locked state, the hole edge is located outside the outer shape of the insertion portion 28 in plan view, as shown in FIG. 4. Therefore, the clamp 20 is rotated by a predetermined angle around the axis 28X in the insertion direction of the insertion portion 28 as shown in FIG. 4 from the locked state shown in FIG. 3, and the insertion portion 28 is pulled out from the attachment hole 12. This allows the clamp 20 to be removed without damaging it. Further, the clamp 20 cannot be removed from the floor panel 10 unless the clamp 20 is rotated by a predetermined angle around the axis 28X in the insertion direction of the insertion portion 28 from the locked state and then the insertion portion 28 is pulled out from the attachment hole 12. Therefore, detachment of the clamp 20 from the floor panel 10 is suppressed.

In addition, in this embodiment, as shown in FIG. 1, the protrusion 14 formed on the floor panel 10 is located near the board portion 22 of the clamp 20 in the locked state, so that the clamp 20 can be moved from the locked state. Rotation to the predetermined angle is restricted by contacting the board portion 22. Further, the clamp 20 is configured such that the board portion 22 can climb over the protrusion 14 by rotating around the axis 28X (see arrow R) in the insertion direction of the insertion portion 28 (see FIG. 2 for both) while elastically bending the board portion 22 on the floor panel 10 away from the floor panel 10. Therefore, the rotation of the clamp 20 attached to the floor panel 10 can be properly restricted and the clamp 20 can be removed without being damaged.

As described above, according to the present embodiment, it is possible to suppress the attached clamp 20 from coming off, and it is also possible to remove the clamp 20 without damaging it. Further, by removing the clamp 20 without damaging it, the clamp 20 can be reused.

Note that in the above embodiment, the floor panel 10 is formed with a protrusion 14 for regulating the rotation of the clamp 20, and such a configuration is preferable, but there may be a configuration in which such a protrusion 14 is not formed.

Although one example of the present disclosure has been described above, the present disclosure is not limited to the above, and it goes without saying that the present disclosure can be implemented with various modifications other than the above without departing from the spirit thereof.

What is claimed is:

1. A wire harness clamp attachment structure for attaching, to a vehicle body-side component, a clamp including a base plate portion to which a wire harness is fixed on one side, wherein
an insertion portion to be inserted into an attachment hole in the vehicle body-side component is provided on the other side of the base plate portion of the clamp, and the insertion portion includes a pair of elastic pieces that is elastically deformable in a mutually facing direction orthogonal to an insertion direction of the insertion portion, and
the attachment hole includes a pair of locked edges configured to lock the elastic pieces, and has a shape in which the clamp is rotatable within a predetermined range about an axis in the insertion direction of the insertion portion from a locked state in which the elastic pieces are locked on the locked edges, and a hole edge is located on an outer side of an external shape of the insertion portion in plan view when the clamp is rotated by a predetermined angle from the locked state.

2. The wire harness clamp attachment structure according to claim 1, wherein:
the vehicle body-side component includes a protrusion that is located near the base plate portion of the clamp in the locked state and is configured to restrict rotation of the clamp by the predetermined angle from the locked state by contact with the base plate portion; and
the clamp is configured to allow the base plate portion to climb over the protrusion by rotating about the axis in the insertion direction of the insertion portion while elastically bending the base plate portion on the vehicle body-side component away from the vehicle body-side component.
